(19) United States
(12) Patent Application Publication
(10) Pub. No.: US 2008/0146203 A1
(43) Pub. Date: Jun. 19, 2008

(54) METHOD AND SYSTEM FOR CONVERSATION BREAK-IN BASED ON SELECTION PRIORITY

(75) Inventors: CHARBEL KHAWAND, MIAMI, FL (US); JEAN KHAWAND, MIAMI, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/613,024

(22) Filed: Dec. 19, 2006

(51) Int. Cl. H04Q 7/38

(52) U.S. Cl. 455/414.1

(57) ABSTRACT

A system (100) and method (200) for conversation break-in based on selection priority is provided. The method can include receiving (202) a request from a first mobile device (112) to break-in an active call (107) of a target mobile device (116), determining (204) a first priority (382) of the first mobile device during the active call, and granting (206) the break-in if the first priority is greater than or equal to a current priority. The current priority can be based on the highest priority of a mobile device engaged in the active call, or on a priority of the mobile device having control of a talk channel. The target mobile device can compare the first priority to a list of priorities (379) or receive priorities from mobile devices engaged in the active call. An indication can be provided when the break-in is granted.

### FIELD OF THE INVENTION

The present invention relates to mobile communication devices, and more particularly, to managing users in a push-to-talk group communication network.

### BACKGROUND OF THE INVENTION

The use of portable electronic devices and mobile communication devices has increased dramatically in recent years. Two primary means of voice communication are generally offered in mobile devices: Interconnect and dispatch. Interconnect is a communication mode by which both parties can speak at the same time. It is considered a two-way communication since both parties can talk and listen on a separate talk channel and a separate receive channel. Interconnect communication is also available for three-way calling or group call. In contrast, dispatch mode is a communication mode be which only one party can speak at a time. The other party can only listen until the first party finishes talking. In practice, a push-to-talk (PTT) key is pressed to acquire control of a talk channel. The talk channel is not released until the PTT key is released. Upon release, another participant can acquire the talk channel. Dispatch mode is also available for three-way dispatch or group dispatch.

During dispatch mode a participant outside of the group call, or the dispatch call, cannot generally acquire the talk channel for a pre-determined amount of time. In dispatch mode, the talker and the listener establish a hard physical link until an inactivity timer expires. Although the activity timer allows for a fast set up time between current users of the group call, it also sets a limit to when the talk channel can be acquired. Accordingly, a participant must either wait for the activity timer to expire, or try to call again at a later time. In a cellular network, once a base station establishes a call session between users or users of the same group (Group call), a busy signal is given to any user who is trying to reach one of the active session members. A base station will return a ‘user busy’ signal to any one if the target is already involved in an active session.

### SUMMARY

One embodiment is directed to a method for intrusive push-to-talk (PPT). The method can include receiving a request from a first mobile device to break-in an active call of a target mobile device, determining a first priority of the first mobile device during the active call, and granting the break-in if the first priority is greater than or equal to a current priority of a mobile device engaged in the active call. The step of determining a first priority can include comparing the first priority to a pre-stored priority list, or receiving priorities from mobile devices engaged in the active call. An indication can be provided when the break-in is granted. The step of granting the break-in can include sending a first message to suspend the active call, sending a second message to accept the call from the first mobile device, and connecting the first mobile device and the target mobile device in a second active call. The suspended call can be automatically reconnected upon termination of the second active call.

One embodiment is directed to a system for push-to-talk (PTT). The system can include a first mobile device that sends a request to break-in an active call of a target mobile device, and a fixed network equipment (FNE) that receives the request and arbitrates the active call of the target mobile device and the break-in of the first mobile device. The target mobile device can receive the request from the first mobile device, compare a first priority of the first mobile device to a list of priorities that identify a break-in priority for mobile devices in the active call, and grant the break-in to the active call if the first priority is greater than a second priority of a second mobile device in the active call. The target mobile device can identify which mobile device is in control of a talk channel during the active call, and evaluate a priority for break-in based on the mobile device that has control of the talk channel. The target mobile device can grant the break-in during a talk time of the target mobile device if the first priority is greater than a priority of the target mobile device.

Another embodiment is directed to a method for push-to-talk (PPT) break-in. The method can include receiving a request from a first mobile device to break-in the group call on a target mobile device already engaged in a group call, wherein the first mobile device is not a member of the group call, determining a first priority of the first mobile device with respect to the user already engaged in the group call based on a priority list, and granting the break-in if the first priority is greater than or equal to a current priority of the users already engaged in the active call, wherein the step of granting the break-in allows transparent connections and suspension to occur without user intervention. The step of granting the break-in can comprise exchanging access control protocol (ACP) messages between the first mobile device and the target mobile device. The step of granting the break-in can comprise exchanging session initiated protocol (SIP) messages between the first mobile device and the target mobile device. In one aspect, the priority list can be a user configured profile. The priority list can be stored in a secure information module (SIM) or removable card that can be moved by the users between the different phones.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a wireless communication system for providing push-to-talk (PTT) break-in based on selection priority in accordance with the embodiments of the invention;

FIG. 2 is a method for providing push-to-talk (PTT) break-in based on selection priority in accordance with the embodiments of the invention;

FIG. 3 is a set of optional steps for evaluating priority in accordance with the embodiments of the invention;

FIG. 4 is a depiction of a group of mobile devices in an active call receiving a break-in request from another mobile device in accordance with the embodiments of the invention;

FIG. 5 is a depiction of a group of mobile devices in a suspended call and a group of mobile devices in a new active call in accordance with the embodiments of the invention;

FIG. 6 is a depiction of a group of mobile devices in a restored active call in accordance with the embodiments of the invention;

FIG. 7 is a depiction of a first mobile device receiving authorization to break-in a call in accordance with the embodiments of the invention;

FIG. 8 is a depiction of a first mobile device unable to receive authorization to break-in a call in accordance with the embodiments of the invention;

FIG. 9 is a flow diagram for push-to-talk (PTT) break-in based on selection priority in accordance with the embodiments of the invention; and

FIG. 10 is a method for granting a break-in request in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The term “talk channel” can be defined as a transmit communication channel that is shared amongst a plurality of mobile devices. The term “talk time” can be defined as the time between when a talk channel is acquired and when the talk channel is released. The term “hang-time” can be defined as the time between when a talk channel is released until the talk channel is again acquired. The term “PTT request” can be defined as an attempt to push to talk, either by hardware or software. The term “PTT key” can be defined as a physical button or a soft-key. The term “soft-key” can be defined as a software controlled button. The term “PTT group call” can be defined as a group call based on push-to-talk requests. The term “break-in” can be defined as disrupting an active call and acquiring the talk channel in the active call, or pre-empting a conversation. The term “priority” can be defined as a control precedence of one mobile device over another mobile device. The term “current priority” can be defined as the priority of the mobile device that has current control of the talk channel. The term “arbitrate” can be defined as negotiating control of a talk channel. The term “target mobile device” can be defined as a mobile device receiving a break-in request from another mobile device. The term “suspend” can be defined as temporarily pausing, or terminating, a call connection of an active call. The term “active call” can be defined as a call connection that is currently in progress, or occurring within an activity timer.

Broadly stated, embodiments of the invention are directed to a method and system that allows an outside user to break-in to an active call based on user-defined rules. The user-defined rules can include a list of priorities that identify which users can break-in to an active call. This allows users with a higher priority to effectively interrupt a call and pass call control resources to the mobile device with the higher priority. Moreover, the user-defined rules establishes priority of break-in for mobile devices not included in a current group call. For example, the user defined rules can be a priority list that defines which users in a call group have precedence of break-in over other users in the call-group. The priority list can be customized for each users, and may also include other users outside the current call group. In such regard, an outside user that is external to the call group can be given precedence over a user already engaged in a group call. Moreover, users can create a priority list that is stored on a mobile device. The priority list identifies other users to whom the user has assigned priorities. In one arrangement, the priority list can be a user configured profile that establishes a ranking order. For example, a parent can be ranked higher than a child for order of break-in priority.

During a group call, the mobile device can automatically check to determine if call requests from users outside the group have higher priority than members in the group call. The member can be automatically connected to the outside member if a priority of the outside member is higher. In such regard, a client device can include a prioritized list which includes not involved in a current active session. The client device can use the priority list to arbitrate between the current active session and a requested session. For example, in a circuit switched call a user having a higher priority can automatically and transparently break-in to an active session of a group call, of which the user is not a group member. The priority can also be established based on a personal profile. For example, the profile can identify if the user is on vacation or at work.

In order to break-in the call, a target mobile device can evaluate the priorities of the users in the active call and the new user attempting to break-in. The target mobile device can refer to a priority list that can be stored locally on the device. Alternatively, the mobile devices can send a priority level to the target mobile device. The priority list can also be stored in a secure information module (SIM) or removable card that can be moved by the users between the different phones. If the new user attempting to break-in the active call has a higher priority relative to a current user in the active call, the target mobile device can send an acknowledge message to infrastructure to accept the call, while it sends a suspend request message to suspend the active call. As one example, a cellular infrastructure can keep track of who is allowed to break into a call. A centralized approach of the cellular infrastructure can employ Internet Protocol (IP) based push-to-talk (PTT) Over Cellular using session initiated protocol (SIP) signaling. An indication can be provided to users in the active call, the target mobile device, and the new user if the break-in succeeds. Once the session with the new user is terminated, the suspended call can be restored allowing the original active call to continue

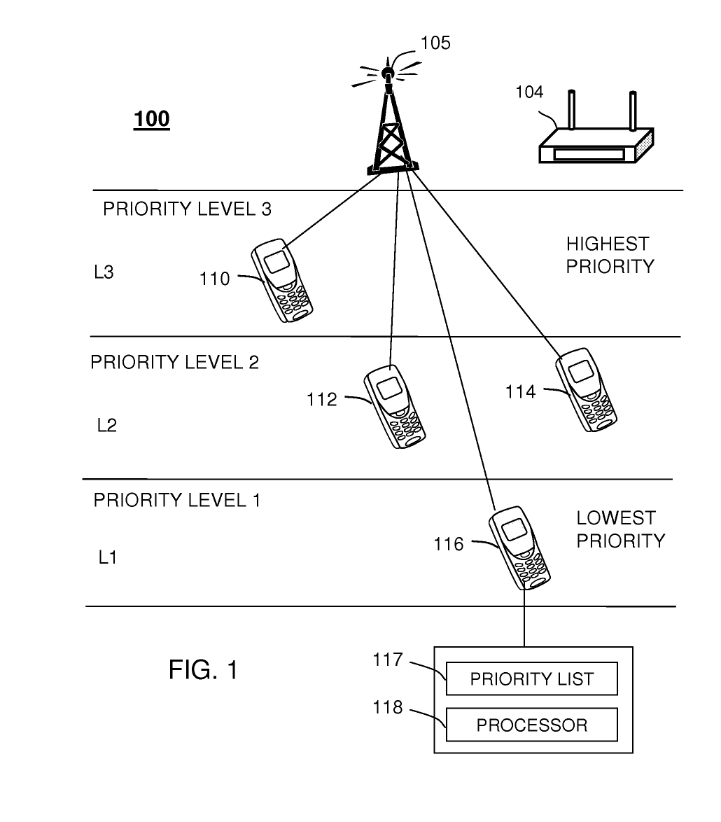

### FIG. 1

Referring to FIG. 1, a wireless communication system 100 for providing push-to-talk (PTT) break-in based on selection priority is shown. In one arrangement, the wireless system 100 can provide wireless connectivity or dispatch connectivity over a radio frequency (RF) communication network. The wireless communication system 100 can also provide push-to-talk (PTT) over cellular (PoC) and Voice over IP (VoIP). The wireless communication system 100 can include a plurality of mobile devices 110-116 communicating amongst one another in a group call or with other mobile devices or servers in the wireless communication system 100. As one example, the mobile devices 110-116 can communicate with one or more cellular towers 105 using a standard communication protocol such as CDMA, GSM, or iDEN, but is not herein limited to these. The one or more cellular towers 105, in turn, can connect the mobile devices through a cellular infrastructure to other mobile devices or resources on other networks.

Mobile devices 110-116 in the wireless communication system 100 can also connect amongst one another over a Wide Local Area Network (WLAN) 104 within an ad-hoc group. The WLAN 104 provides wireless access within a local geographical area. The mobile devices 110-116 can communicate with the WLAN 104 according to the appropriate wireless communication standard. In another arrangement, the mobile devices can communicate amongst themselves in a peer-to-peer ad-hoc network without infrastructure or WLAN support. For example, the mobile device can use short-range radio communication to engage in a group call in a peer-to-peer mode. In a typical WLAN implementation, the physical layer can use a variety of technologies such as 802.11b or 802.11g Wireless Local Area Network (WLAN) technologies. The physical layer may use infrared, frequency hopping spread spectrum in the 2.4 GHz Band, or direct sequence spread spectrum in the 2.4 GHz Band, or any other suitable communication technology.

Briefly, a mobile device 116 can include a priority list 117 that identifies an order of break-in precedence. The mobile device 116 can also include a processor 118 which grants the break-in based on the priority list 117. The wireless communication system 100 provides call handling control to allow call break-in to a conversation. The mobile devices can be ordered by a priority of break-in. The priority identifies a precedence by which mobile devices can break-in to an active call of another mobile device. An active call may be a dispatch group call between two or more mobile devices. For example, mobile device 110 can have a priority level 3 which can be the highest priority for break-in. Mobile device 112 and mobile device 114 can have a priority level 2 which is the second highest priority level. Mobile device 116 can have priority level 1 which is the lowest priority level. Notably, the number of priority levels can be more than or less than the number of priority levels shown. For instance, if mobile device 112 is in an active call with mobile device 114, then mobile device 110 can break-in to the active call. This is because, mobile device 110 has a higher priority than either mobile device 112 of mobile device 114

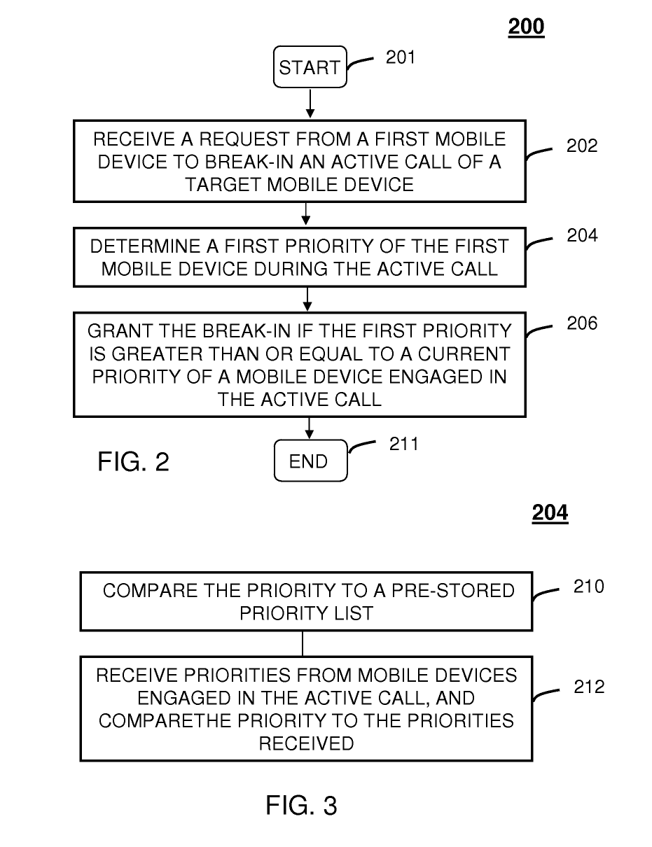

### FIG. 2

Referring to FIG. 2, a method 200 for providing push-to-talk (PTT) break-in based on selection priority is shown. The method 200 can be practiced with more or less than the number of steps shown. To describe the method 200, reference will be made to FIG. 3-6, although it is understood that the method 200 can be implemented in any other manner using other suitable components. In addition, the method 200 can contain a greater or a fewer number of steps than those shown in FIG. 2.

At step 201, the method 200 can start. The method 200 can start in a state where at least two mobile devices are in an active call. As an example, the active call can be a PTT dispatch call over a RF communication link, a VoIP call in PoC, or an instant voice chat application. The active call can include a target mobile device and a second mobile device. The target mobile device is the mobile device that receives a break-in request.

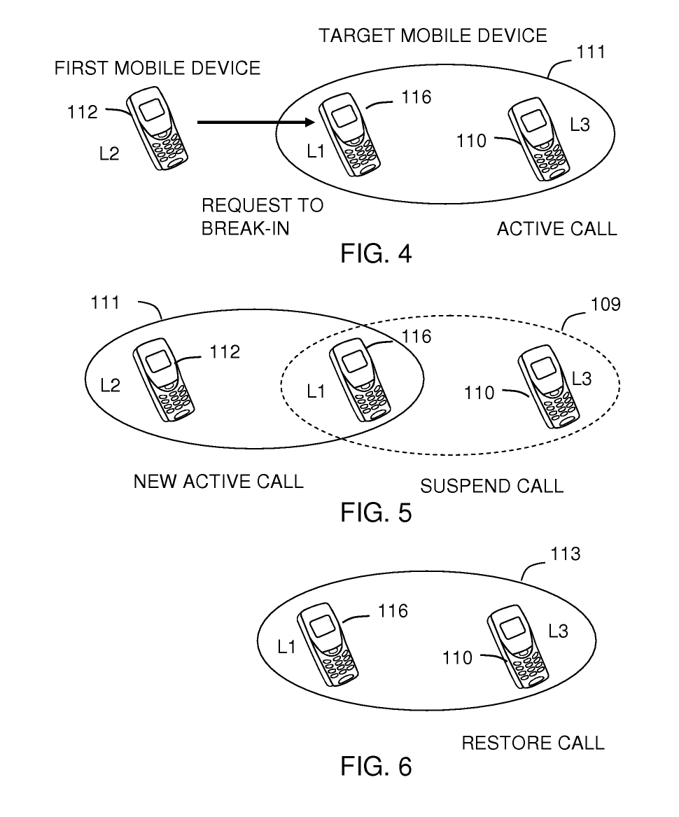

At step 202, a request can be received from a first mobile device to break-in an active call of the target mobile device. For example, referring to FIG. 4, an exemplary depiction of a group call supporting break-in is shown. As illustrated, the target mobile device 116 can be in an active call 107 with the second mobile device 110. The first mobile device 112 can request a break-in to the target mobile device 116 during the active call 107. In particular, the first mobile device 112 sends the request to the target mobile device 116.

At step 204, a first priority of the first mobile device during the active call can be determined. For example, referring to FIG. 4, the target mobile device 116 receiving the request from the first mobile device 112 can assess the priority of the request. As one example, shown in FIG. 3, the step of determining a first priority can further include comparing (210) the first priority to a pre-stored priority list 117. For instance, the target mobile device 116 can include a list of priorities for mobile devices. The priority list 117 can be established by the user or by a service provider. As another example, shown in FIG. 3, the step of determining a first priority can further include receiving priorities from mobile devices engaged in the active call, and comparing the priority to the priorities received. For example, referring back to FIG. 4, the first mobile device 112 can send a message to the target mobile device 116 indicating the priority of the first mobile device 112 if it is not in the priority list 117.

### FIG. 4

At step 206, the break-in can be granted if the priority is greater than or equal to a current priority of a mobile device engaged in the active call. For example, referring to FIG. 4, the target mobile device 116 is in an active call with the second mobile device 110. The target mobile device 116 has an L1 priority and the second mobile device 110 has an L3 priority. The first mobile device 112 requesting the break-in has a priority of L2. In one arrangement, the priority of break-in depends on the mobile device that has the highest priority in the active call 107. In such regard, the mobile device with the highest priority in the active call 107 sets the break-in priority. For example, referring to FIG. 4, the second mobile device 110 with a priority of L3 sets the priority. Accordingly, only a mobile device of priority L3 or higher can break-in the active call 107. Consequently, the first mobile device 112 cannot break in the active call 107, until the second mobile device 110 terminates the active call 107 with mobile device 110. Accordingly, the first mobile device 110 must wait for the active call 107 to end, based on the order of priority.

### FIG. 5

Upon determining the priority of the first mobile device 112, the target mobile device 116 can authorize the break-in if the priority of the first mobile device 112 is greater than or equal to the priority of the target mobile device 116 and the second mobile device 110. In order to break-in, the active call 107 is first suspended 109 to disengage the target mobile device 116 with the second mobile device 110. As an example, referring to FIG. 5, the target mobile device 116 can suspend the active call 107 by sending a message to a fixed network equipment (FNE) supporting the call thereby producing a suspended call 109. After the break-in has been granted, a new active call 111 can be set up between first mobile device 112 and target mobile device 116 as shown in FIG. 5.

An indication can be provided to all parties on the active call, the target mobile device 116, and the first mobile device 112 when the break-in is granted. For example, an automated indication can be presented to the target mobile device 116 to inform the mobile device 116 that a new call is being set up with the first mobile device 112. An automated indication can also be presented to the second mobile device 110 to inform the second mobile device 110 that the active call is being temporarily suspended. After the new active call has terminated, the original active call can be restored 113 as shown in FIG. 6. Returning back to FIG. 2, at method step 211, the method 200 can end.

In another arrangement, the priority of break-in can depend on which mobile device has control of the talk channel. Briefly, a mobile device has control of the talk channel when a user has acquired a transmit channel through a PTT request. For example, a user that has pressed the PTT button, and has acquired resources to transmit on the talk channel, has control of the talk channel. The user can talk while control of the talk channel is acquired, which corresponds to the talk time. During talk-time the mobile device that initiated the communication has control of the talk channel.

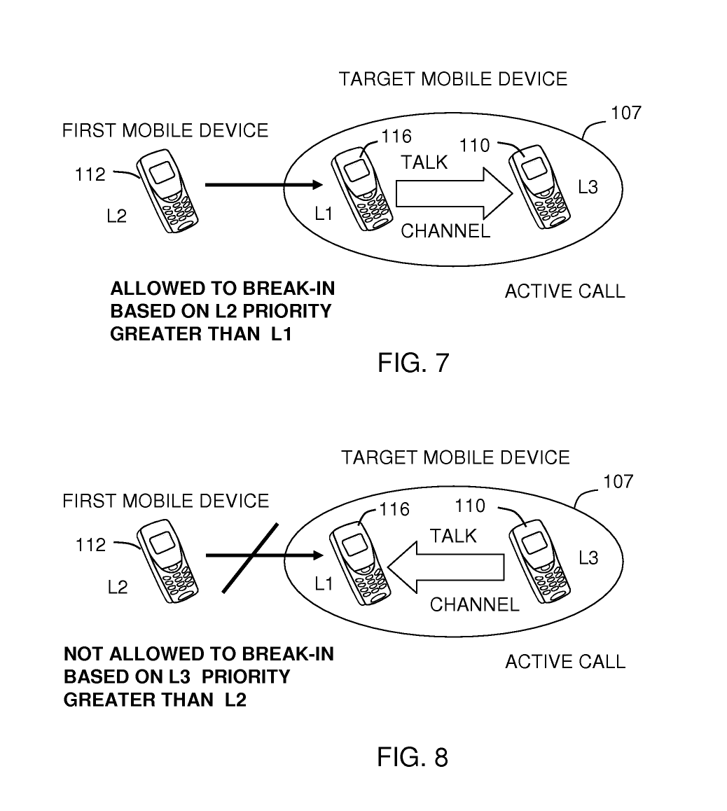

### FIGS. 7/8

FIGS. 7 and 8 provide a depiction for authorizing break-in priority based on a current control of the talk channel. In particular, during dispatch communication, only one radio at a time can acquire the talk channel. The method 200 of break-in based on selection priority prevents a low priority device from overriding a high priority device. However, it allows a mobile device to break-in to a conversation of a higher priority device, though it does not allow the mobile device to interrupt the higher priority device. In this case, a user can break in to a conversation with a higher priority mobile device, though, the lower priority device cannot directly interrupt the higher priority mobile device.

For example, as shown in FIG. 7, the first mobile device 112 can only break into the active call when the lower priority mobile device 116 has control of the talk channel. That is, the first mobile device 112 can break-in the active call to the target device 116 during a talk-time of the target mobile device 116, since the first priority of the first mobile device 112 is greater than the priority of the target mobile device 116.

Referring to FIG. 8, the first mobile device 112 cannot break into the active call when the higher priority mobile device 110 has control of the talk channel. That is, the first mobile device 112 cannot break-in to the active call 107 during a talk-time of the second mobile device 110, since the priority of the second mobile device 110 is greater than the priority of the first mobile device 112.

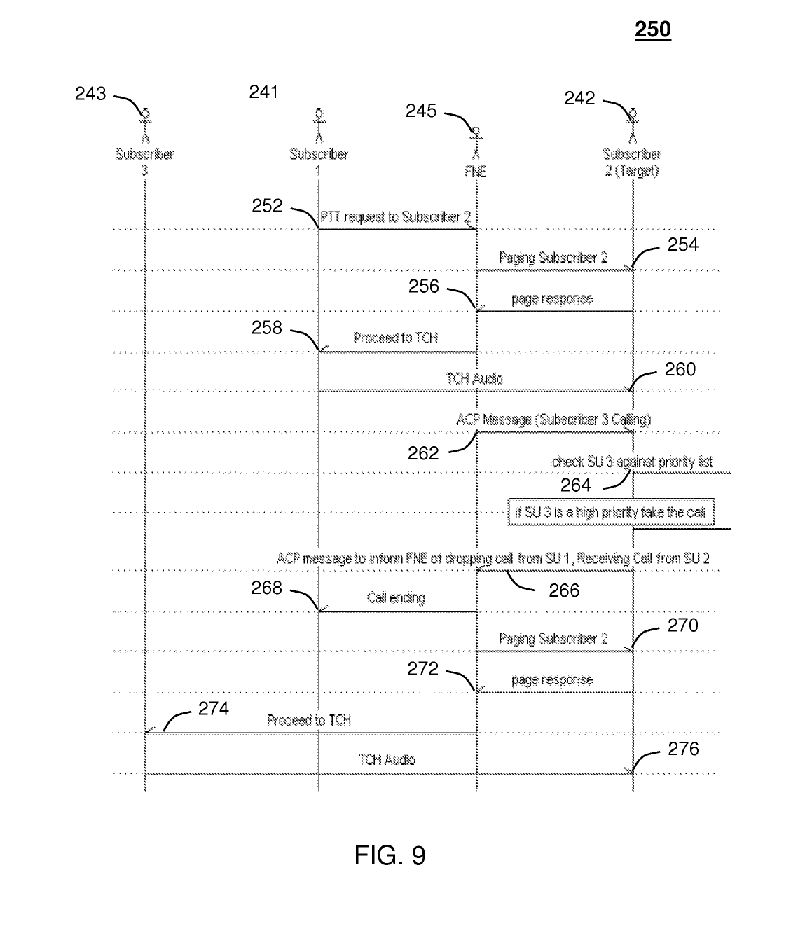

### FIG. 9

Referring to FIG. 9, a flow diagram 250 of push-to-talk (PTT) break-in based on selection priority is shown. In particular, the flow diagram 250 illustrates an exchange of communications for allowing break-in. Briefly, the flow diagram 250 identifies a currently active call between Subscriber 1 (241) and Subscriber 2 (242). A fixed network equipment (FNE) 245, such as a base station or cell tower 105 (See FIG. 1), supports voice and data communication between Subscriber 1 (241) and Subscriber 2 (243). The flow diagram 250 reveals that Subscriber 3 (243) attempts to break in the active call. In the example flow diagram, break-in priority can be granted based on the priority of Subscriber 3 (243) over the priority of Subscriber 2 (242).

At step 252, Subscriber 1 (241) can send a PTT request to Subscriber 2 (242). At step 254, the FNE 245 can page Subscriber 2 (242). For example, the FNE 245 can search for the location of Subscriber 2 (242) in the wireless communication network 100 (See FIG. 1). At step 256, Subscriber 2 (242) can respond to the page request. At step 258, the FNE 245 can proceed to establish a transmission control channel (TCH). At step 260, the call can be connected to create an active call allowing Subscriber 1 (241) to send and receive audio over a communication channel to Subscriber 2 (242). During the active call, Subscriber 1 (241) or Subscriber 2 (242) can acquire the talk channel through a PTT request. During the active call, Subscriber 3 (243) can request a break-in to the active call between Subscriber 1 (241) and Subscriber 2 (242).

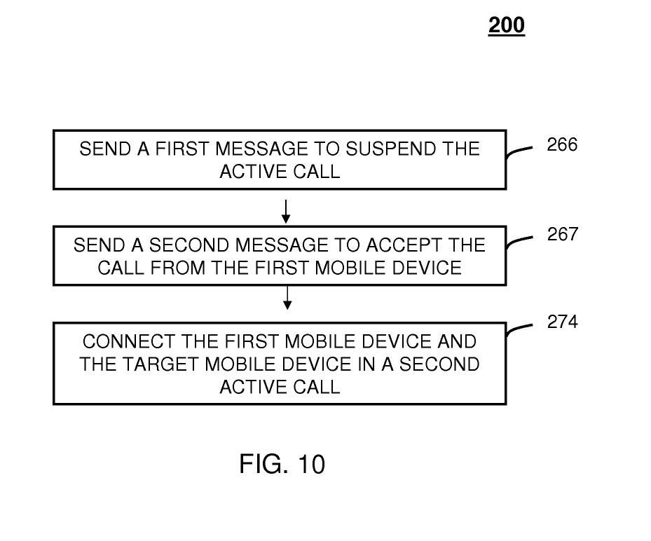

### FIG. 10

At step 262, the FNE 245 can send an ACP message to Subscriber 2 (242) indicating that Subscriber 3 (243) wants to break-in the active call. At step 264, Subscriber 2 (242) can assess a priority of Subscriber 3 (243). For example, Subscriber 2 (242) can identify a priority of Subscriber 3 (243) from a locally stored priority list 117. As another example, Subscriber 2 (242) can send a priority level associated with the break-in request. At step 266, Subscriber 2 (242) can send an ACP message to the FNE 245 to suspend, or terminate, the currently active call (See also method 266 of FIG. 10). Subscriber 2 (242) can also send a message to accept the call from Subscriber 3 (243) (See also method 267 of FIG. 10). Upon granting acceptance of the request to break-in from Subscriber 3 (243), the FNE 245 can end the call between Subscriber 1 (241) and Subscriber 2 (242) at step 268. At this point, the call has been torn down, and a new call can be set up to establish communication between Subscriber 1 (241) and Subscriber 3 (243). Accordingly, at step 270, the FNE 245 can page Subscriber 2 (242) for the new call with Subscriber 3 (243). At step 272, Subscriber 2 (242) can accept the page, and, at step 274, the FNE 245 can proceed to establish the new call with Subscriber 3 (243). At step 276, the call can be connected between Subscriber 1 (241) and Subscriber 3 (243) (See also method 274 of FIG. 10).

In one arrangement, the flow diagram 250 of FIG. 9 can be implemented in an integrated Dispatch and Enhanced Network (iDEN) or a Global Systems Mobile (GSM) network. The flow diagram can also be implemented by a Voice over IP (VoIP) packet switched network, wherein the messages are communicated using Session Initiated Protocol (SIP) messaging for call set up. In practice, the network can identify when a subscriber is requesting a break-in to an active call. The network can send an ACP control message during the active session to the target radio. The target will then check the priority of the caller while the active session is maintained. If the new user has a higher priority relative to the current one, the radio will send an ACP acknowledge accepting the call while it sends a ‘suspend request’ back to the current one. Once the session with the new user is terminated, the suspended user can be optionally contacted again.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for intrusive push-to-talk (PPT), the method comprising:
receiving a request from a first mobile device to break-in an active call of a target mobile device;
determining a first priority of the first mobile device during the active call; and
granting the break-in if the first priority is greater than or equal to a current priority of a mobile device engaged in the active call,
wherein the break-in is based on a priority list that identifies users in the active call and also users outside the active call that are not engaged in the active call.

2. The method of claim 1, wherein the priority list is stored in a secure information module (SIM) on the target mobile device or in a removable card that can be moved by the users between the different phones

3. The method of claim 1, wherein the step of determining a first priority further comprises:
receiving priorities from mobile devices engaged in the active call; and
comparing the first priority to the priorities received in view of the priority list.

4. The method of claim 1, further comprising providing an indication when the break-in is granted.

5. The method of claim 1, wherein the active call is between the first mobile and the target mobile device, and the first mobile device breaks in the active call to the target device during a talk-time of the target mobile device, if the first priority of the first mobile device is greater than the second priority of the target mobile device.

6. The method of claim 1, wherein the active call is between the target mobile and a third mobile device, and the first mobile device breaks in the active call during a talk-time of the third mobile device, if the first priority of the first mobile device is greater than a third priority of the third mobile device.

7. The method of claim 1, wherein the active call is between the target mobile and a third mobile device, and the first mobile device breaks in the active call during a talk-time of the target mobile device, if the first priority of the first mobile device is greater than the second priority of the target mobile device.

8. The method of claim 1, wherein the step of granting the break-in further comprises:
sending a first message to suspend the active call;
sending a second message to accept the call from the first mobile device; and
connecting the first mobile device and the target mobile device in a second active call.

9. The method of claim 5, further comprising:
automatically reconnecting the target mobile device to restore the active call upon termination of the second active call.

10. A system for push-to-talk (PTT), the system comprising:
a fixed network equipment (FNE) that receives a request from a first mobile device to break-in an active call of a target mobile device and arbitrates the active call of the target mobile device and the break-in of the first mobile device,
wherein the target mobile device receives the request from the first mobile device, compares a first priority of the first mobile device to a list of priorities that identify a break-in priority for mobile devices in the active call, and grants the break-in to the active call if the first priority is greater than a second priority of a second mobile device in the active call.

11. The system of claim 10, wherein the target mobile device identifies which mobile device is in control of a talk channel during the active call, and evaluates a priority for break-in based on the mobile device that has control of the talk channel.

12. The system of claim 11, wherein the target mobile device grants the break-in during a talk time of the target mobile device if the first priority is greater than a priority of the target mobile device.

13. The system of claim 11, wherein the target mobile device grants the break-in during a talk time of the second mobile device if the first priority is greater than the second priority.

14. The system of claim 10, wherein the target mobile device:
sends a suspend request message to the FNE to suspend the active call;
sends an acknowledge message to accept the call from the first mobile device; and
connects the first mobile device and the second mobile device in a second active call.

15. The system of claim 10, wherein the acknowledge message is communicated via an Access Control Protocol (ACP) message, or a session initiated protocol (SIP) message

16. A method for push-to-talk (PPT) break-in, the method comprising:
on a target mobile device already engaged in a group call, receiving a request from a first mobile device to break-in the group call, wherein the first mobile device is not a member of the group call,
determining a first priority of the first mobile device with respect to the user already engaged in the group call based on a priority list; and
granting the break-in if the first priority is greater than or equal to a current priority of the users already engaged in the active call,
wherein the step of granting the break-in allows transparent connections and suspension to occur without user intervention.

17. The method of claim 16, wherein the granting the break-in comprises exchanging access control protocol (ACP) messages between the first mobile device and the target mobile device.

18. The method of claim 16, wherein the granting the break-in comprises exchanging session initiated protocol (SIP) messages between the first mobile device and the target mobile device.

19. The method of claim 16, wherein the priority list is stored in a secure information module (SIM) or removable card that can be moved by the users between the different phones.

20. The method of claim 16, wherein the priority list is a user configured profile.
